(19) United States
(12) Patent Application Publication
(10) Pub. No.: US 2016/0157093 A1
(43) Pub. Date: Jun. 2, 2016

(54) SYSTEM AND METHOD FOR UPDATING FIRMWARE THROUGH HETERO-NETWORK

(71) Applicants: Inventec (Pudong) Technology Corporation, Shanghai (CN); Inventec Corporation, Taipei City (TW)

(72) Inventor: Xiao Jiang, Shanghai (CN)

(21) Appl. No.: 14/663,124

(22) Filed: Mar. 19, 2015

(30) Foreign Application Priority Data
Nov. 28, 2014 (CN) 201410707968.8

(51) Int. Cl. H04W 8/24; H04W 4/00

(52) U.S. Cl. CPC H04W 8/245; H04W 4/001; H04W 88/06

(57) ABSTRACT

A system and method for updating a firmware through a hetero-network are disclosed, a target device switches to connect to a second wireless communications network from a first wireless communications network and receives an update file through the second wireless communications network upon receiving an update instruction, and then connects back to the first wireless communications network from the second wireless communications network after finishing the firmware updating by using the update file, whereby the issue encountered in the prior art may be solved where a bandwidth used by other devices working normally may be avoided influencing when downloading new firmware and the technical efficacy updating the firmware of concurrent multiple target devices may be further achieved.

### CROSS-REFERENCE TO RELATED APPLICATION

This application claims the benefit of Chinese Patent Application No. 201410707968.8, filed Nov. 28, 2014.

### BACKGROUND OF THE RELATED ART

1. Technical Field

The present invention relates to a firmware updating system and method, and particularly to a system and method for updating the firmware by using a hetero-network.

2. Related Art

For devices using a wireless communications network, updating their firmware by using a conventional programmer seems not practicable. This is because these devices may possibly distribute over different sites and thus an administration may not possibly proceed the updating task by accessing the sites where these devices are. Therefore, the currently available manner is transmitting a new firmware to these devices, so that the new firmware may be updated after being received.

For such firmware updating manner, it is required to have a particular bandwidth for the firmware updating. However, the other devices operating concurrently may also require its bandwidth for data transmission, resulting in an effect between the device being updated with its firmware and the devices operating normally.

In view of the above, it may be known that there has long been the issue that the bandwidth used by the other devices operating normally is adversely affected when a firmware is downloaded. Therefore, there is quite a need to set forth an improvement means to settle down this problem.

### SUMMARY

In view of the issue that a bandwidth used by other devices operating normally is adversely affected when a firmware is downloaded encountered in the prior art, the present invention provides a system, device, and method for updating the firmware by using a hetero-network.

According to the present invention, the system for updating a firmware by using a hetero-network, comprising a management end, transmitting an update instruction through a first wireless communications network; an update device, transmitting an update file through a second wireless communications network; and a target device, storing a firmware therein, switching to connect to the second wireless communications network from the first wireless communications network and receiving the update file through the second wireless communications network upon receiving the update instruction through the first wireless communications network, updating the firmware by using the update file, and switching back to connect to the first wireless communications network from the second wireless communications network.

According to the present invention, the device for updating a firmware by using a hetero-network, comprising a wireless communications network module, connecting a first wireless communications network and receiving an update instruction through the first wireless communications network, and connecting a second wireless communications network and receiving an update file through the second wireless communications network; a storage medium, storing a firmware therein; an update module, electrically connected to the wireless communications network module and the storage medium, and updating the firmware by using the update file; and a switch module, electrically connected to the wireless communications network module, the storage medium and the update module, which switching to connect to the second wireless communications network from the first wireless communications network upon receiving the update instruction through the first wireless communications network, and switching back to connect to the first wireless communications network from the first connection with the second wireless communications network upon finishing the updating the firmware by the update module.

According to the present invention, the method for updating a firmware by using a hetero-network, comprising steps of transmitting an update instruction through a first wireless communications network by a management end to a target device; transmitting an update file through a second wireless communications network an update device; switching to connect to the second wireless communications network from the first wireless communications network upon receiving the update instruction through the first wireless communications network by the target device; transmitting an update file through the second wireless communications network by an update device; receiving the update file through the second wireless communications network by the target device, and updating a firmware stored in the target device by using the update file; and switching back to connect to the first wireless communications network from the second wireless communications network by the target device.

The system and method of the present invention has the difference as compared to the prior art that the target device switches to connect to the second wireless communications network from the first wireless communications network and receives the update file through the second wireless communications network upon receiving the update instruction, and then connects back to the first wireless communications network from the second wireless communications network after finishing the firmware updating by using the update file, whereby the issue encountered in the prior art may be solved and the technical efficacy updating the firmware of concurrent multiple target devices may be achieved.

### BRIEF DESCRIPTION OF THE DRAWINGS

The present invention will become more fully understood from the detailed description given herein below illustration only, and thus is not limitative of the present invention, and wherein:

FIG. 1 is a system architecture diagram of a system for updating a firmware by using a hetero-network according to the present invention;

FIG. 2 is a schematic diagram of elements of the system for updating the firmware by using the hetero-network according to the present invention;

FIG. 3 is a schematic diagram of a storage structure of a storage medium used in the present invention;

FIG. 4A is a flowchart of a method for updating the firmware by using the hetero-network according to the present invention; and

FIG. 4B is a flowchart of a process of detecting and selecting a target device used in the method for updating the firmware by using the hetero-network according to the present invention.

### DETAILED DESCRIPTION

The present invention will be apparent from the following detailed description, which proceeds with reference to the accompanying drawings, wherein the same references relate to the same elements.

The present invention may enable a connection of a target device with a wireless communications network differing from the one when the target device works normally for downloading an update file for updating a firmware, and the connection may be switched back to the one when the target device works normally after the firmware updating is finished. It is to be noted that the wireless communications network recited herein is not merely limited to WiFi, ZigBee, bluetooth, etc.

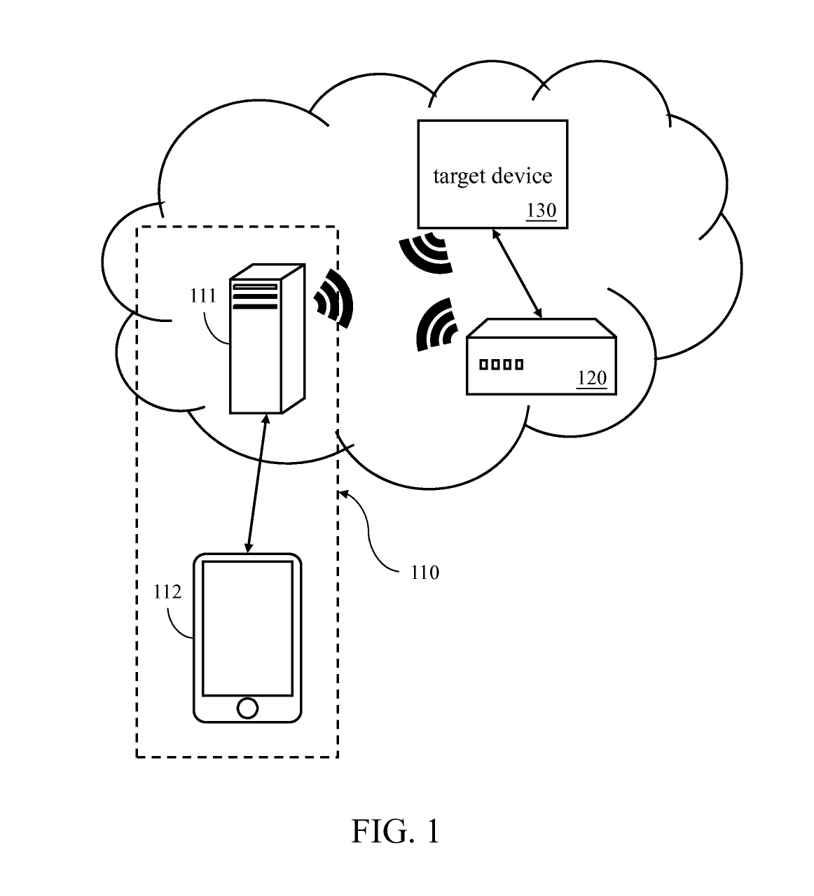

Referring first to FIG. 1, a system architecture diagram of a system for updating a firmware by using a hetero-network according to the present invention is shown therein for description of the operation thereof. As shown in FIG. 1, the system of the present invention comprises a management end 110, an update device 120, and a target device 130.

The management end 110 is connected to a first wireless communications network, and used to transmit an update instruction to the target device 130 through the first wireless communications network. In addition, the management end 110 may also transmit a transmission instruction to the update device 120 through the first wireless communications network.

In some embodiments, the management end 110 may receive a response message transmitted from the target device 130 through the first wireless communications network, so as to establish a device list. The response message received at the management end 110 may comprise an identification of the target device 130 transmitting the response message. The device list established by the management end 110 may comprise the identification of the target device 130 recorded within the response message received. However, the response message and device list are not merely limited to the cited examples. In some other embodiments, the management end 110 may directly receive the device list transmitted by the update device 120 through the first wireless communications network.

The management end 110 may also select one or more target devices 130 to be updated from the device list. If the management end 110 does not establish or receive the device list, the management end 110 may select all the target devices 130 to be updated.

In some embodiments, the management end 110 may comprises a management server end 111 and a management client end 112. The management client end 112 may be an application (APP) used and executed on a mobile device, which may be a smart phone, a tablet computer, a notebook computer, etc. However, these are merely examples without limiting the present invention.

The management server 111 may connect to the first wireless communications network and establish or receive the device list. The management client end 112 may connect to the management server 111 through a cable or wireless communications network, so that it may update one or more target devices recorded in the device list established or received by the management server 111, and the management server 111 may transmit an update instruction to the target device 130 selected by the management client end 112.

The update device 120 is connected to the second wireless communications network and transmits the update file to the target device 130 through the second wireless communications network. Generally, one single packet cannot transmit an entire update file. Therefore, the update device 120 may divide the update file into fragments, then introduce them into the respective packets and then transmit the packets to the target device 130 one by one. In some embodiments, the update device 120 may continuously broadcast in turn the packets including the different fragments to the second wireless communications network, so that all the target devices 130 having received the broadcast packets from the update device 120 through the second wireless communications network. For example, the update device 120 may sequentially broadcast each of the fragments from the first one, and broadcast each of the fragments from the first one again after the last one of the fragments has been broadcast.

The update device 120 may transmit the update file through the second wireless communications network after booting, until the broadcast has a number reaching a predetermined number of times or a predetermined time, or even until its shut-down. However, these are merely examples without limiting the present invention. For examples, the update device 120 may also be connected to the first wireless communications network and receive a transmission instruction or stop instruction transmitted by the management end 110 through the first wireless communications network. After the update device 120 receives the transmission instruction transmitted by the management end 110, it may transmit the update file through the second wireless communications network. On the other hand, when the update device 120 receives the stop instruction, the update file may be stopped for its transmission.

In addition, the update device 120 may broadcast a detection message to the target device 130 through the first wireless communications network and receive a response message transmitted back from the target device 130 through the first wireless communications network. And, the update device 120 may also establish the device list according to the received response message and transmit the device list to the management end 110. In some embodiments, the processes of broadcasting the detection message and receiving the response message, establishing and transmitting the device list mentioned above may also be achieved by an additional detection device (not shown).

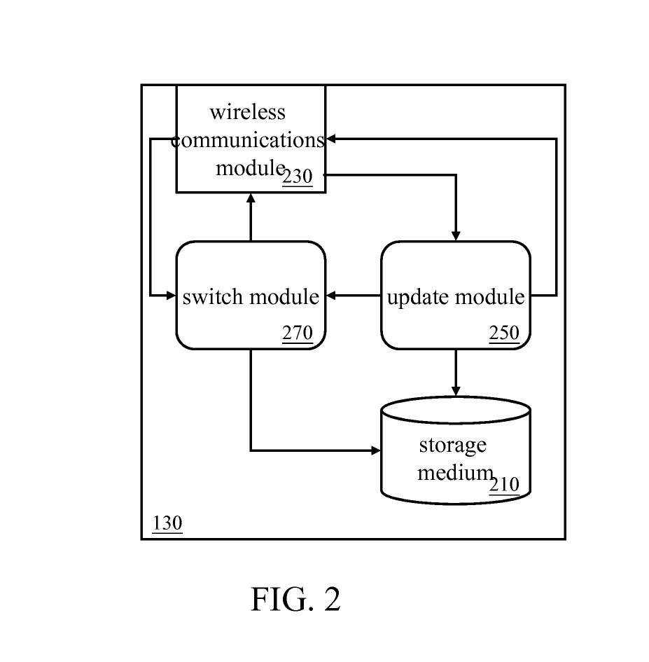

The target device 130 is used for firmware updating. The target device 130 may comprise, as shown in FIG. 2, a storage medium 210, a wireless communications module 230, an update module 250, and a switch module 270.

The storage medium 210 is used for storing a firmware. Generally, the target device 130 loads in the firmware stored in the storage media 210 and operates by using the loaded-in firmware after booting. However, this is merely an example, without limiting the present invention.

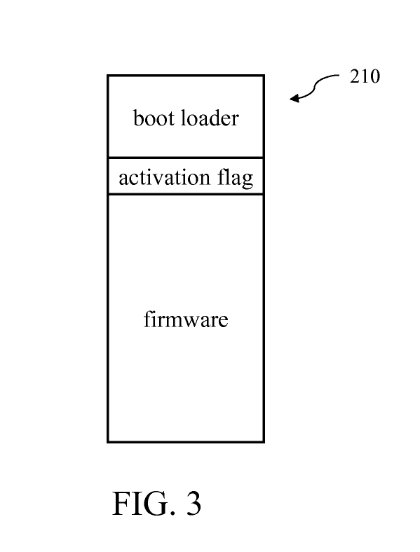

The storage medium 210 may be read and written and may be a flash memory, an electrically-erasable programmable read-only memory (EEPROM), etc. However, these are merely examples without limiting the present invention. In some embodiments, the storage medium 210 may sequentially store a load-in program, an activation flag, and a firmware, as shown in FIG. 3. The load-in program, activation program and firmware stored in the storage medium 210 each have its block size as fixed. That is, a begin site for storage of the load-in program, activation flag and firmware is pre-defined and fixed, respectively.

The wireless communications module 230 may be connected to the first wireless communications network or the second wireless communications network. It is to be noted that the wireless communications module 230 may only be connected to the first or second wireless communications networks at the same time.

The wireless communications module 230 receives the update instruction transmitted from the management end 110 through the first wireless communications network and the update file transmitted by the update device 120 through the second wireless communications network.

The wireless communications module 230 may receive the detection message transmitted from the update device 120 or a detection device through the first wireless communications network, and transmit the response message corresponding to the detection message to the update device 120 or the management end 110.

The wireless communications module 230 may also transmit an update success message to the management end 110 through the first wireless communications network when the update module 250 finishes updating the firmware.

The update module 250 updates the firmware stored in the storage medium 210 by using the update file received at the wireless communications module 230. In some embodiments, the update module 250 may directly write the particular fragment of the update file received at the wireless communications module 230 into a corresponding site in the storage medium 210, until all the fragments of the update file are received and written into the storage medium 210, whereby the firmware updating process is finished. For example, when the wireless communications module 230 receives the 28th fragments, the update module 250 may write the received fragment into the storage medium 210 from a site of a result of a begin site for storing the firmware plus 889208((28−1)*413*8)bits provided that each fragment has a length of 413 bytes. In some other embodiments, the update module 250 may combine first the update file received at the wireless communications module 230 into a complete update file, and then write the update file into the storage medium 210 from a begin site for storing the firmware.

The switch module 270 is used to switch the connection of the wireless communications network 230 from the first wireless communications network to the second communications network upon receiving the update instruction transmitted from the management end 110, and switch the connection of the wireless communications network 230 from the second wireless communications network to the first communications network upon finishing the firmware updating by the update module 250.

In some embodiments, the switch module 270 may set an activation flag, so that the target device 130 may select the wireless communications module 230 to get connected to the first or second wireless communications networks according to the activation flag. For example, the switch module 270 may write into a location where the activation flag is stored in the storage medium 210 to point out that the firmware wants to update upon receiving the update instruction by the wireless communications module 230, and reboot the target device 130. In this manner, during booting, the target device 130 may determine the firmware needs update after reading out the activation flag stored in the storage medium 210. Hence, the wireless communications module 230 is selected to get connected to the second wireless communications network. At the same time, after the update module 250 finishes updating the firmware, the switch module 270 may write into the location storing the activation flag in the storage medium 210 to indicate a normal booting and thus reboot the target device 130. In this manner, during the target device 130 rebooting, after reading out the activation flag stored in the storage medium 210, the target device 130 may be determined as a normal operation and thus the wireless communications module 230 is selected to connect to the first wireless communications network.

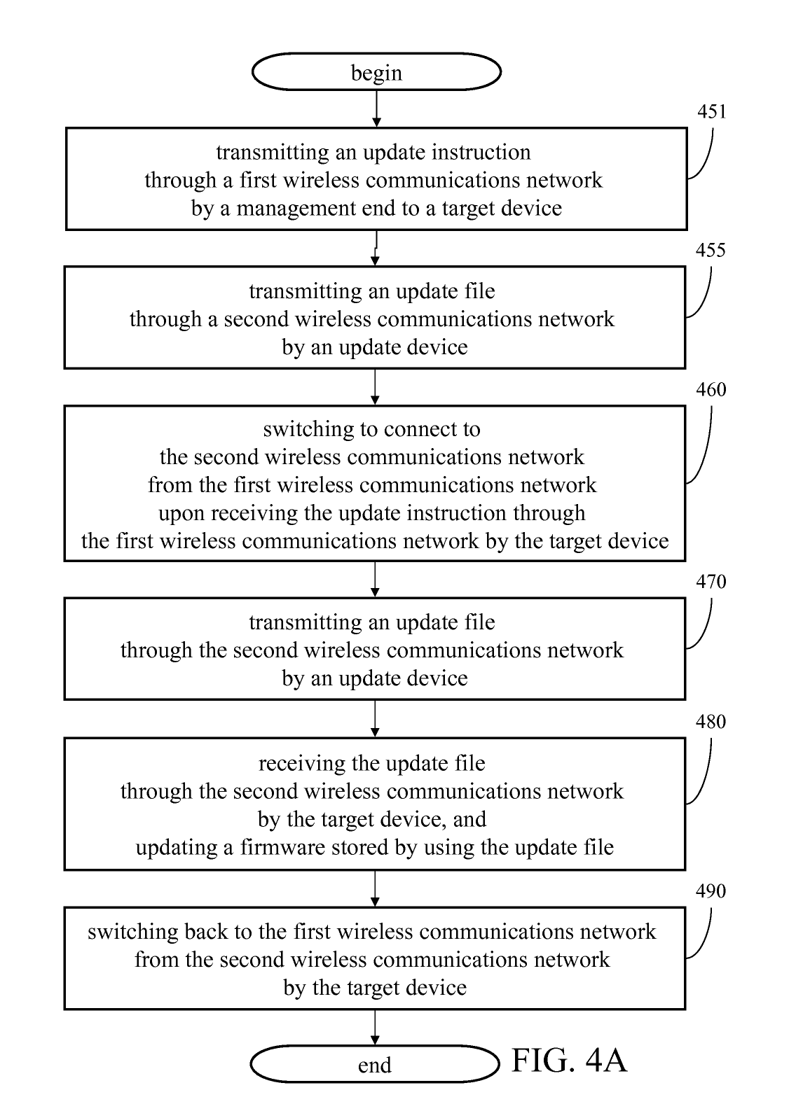

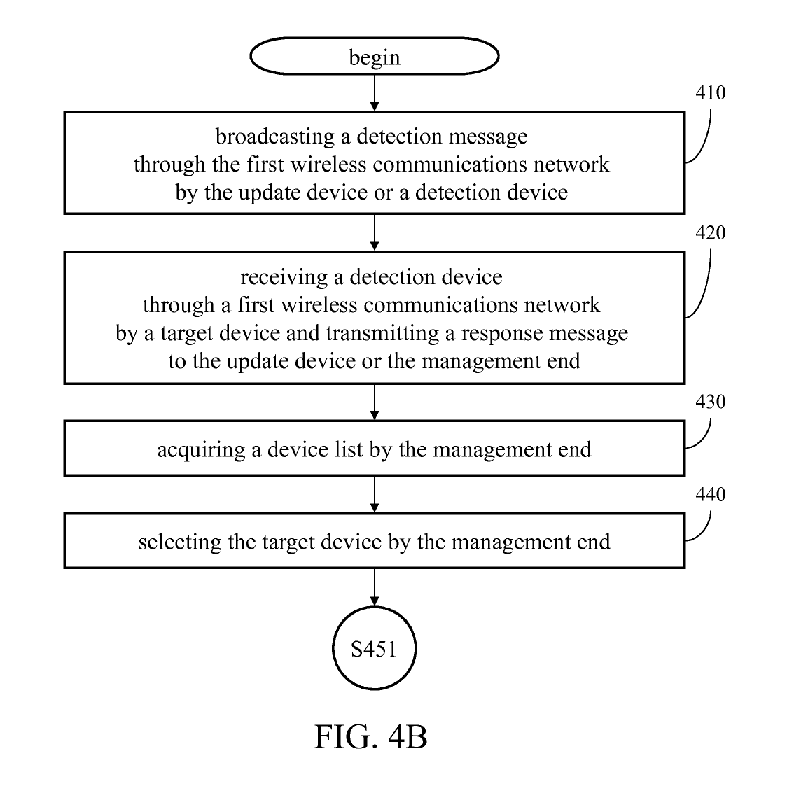

Thereafter, an embodiments will be set forth to explain how the system and method of the present invention are operated, with simulate reference to FIG. 4A, which is a flowchart of a method for updating the firmware by using the hetero-network according to the present invention. In this embodiment, assume the first wireless communications network is a ZigBee network, while the second wireless communications network is a WiFi network. However, the first and second wireless communications networks are not merely limited to the above.

At first, the management end 110 may transmit the update instruction to the target device 130 through the first wireless communications network (S451). In this embodiment, assume the management end 110 comprises the management server 111 and a management program executed on a smart phone used by the manager (management client end 112), the management server 111 may transmit the update instruction to the target device 130 after the manager operates the management client end 112 to transmit the update message to the management server 111.

After the target device 130 at the wireless communications module 230 receives the updated instruction transmitted from the management end 110 through the first wireless communications network, the switch module 270 at the target device 130 may switch the connection of the wireless communications module 230 from the first to second wireless communications networks (S460). In this embodiment, assume the switch module 270 may write into the storage medium 210 of the target device 130 with the activation flag presenting the firmware is under updating, and reboot the target device 130. During the target device 130 rebooting, the target device 130 may first execute the boot loader and then read out the activation flag, and determine if the booting is normally according to the activation flag. Since the activation flag presents the firmware is required to be updated, the boot loader may select the wireless communications module 230 to get connected with the second wireless communications network. In this manner, the wireless communications module 230 may switch its connection with the first wireless communications network to the second wireless communications network.

In addition, before the management end 110 transmit the update instruction to the target device 130 through the first wireless communications network (S451), after the switch module 270 at the target device 130 switches the connection of the wireless communications module 230 from the first to the second wireless communications networks (S460), or in the process of steps S460 and S451, the update device 120 may transmit eh update file through the second wireless communications network (S470). In this embodiment, the update device 120 may transmit the update file through the second wireless communications network (S470). In this embodiment, assume the update device 120 may divide the update file into multiple fragments, and continuously broadcast each of the fragments onto the second wireless communications network.

In addition, if the update device 120 may be connected to the first wireless communications network, the management end 110 may also transmit the transmission instruction to the update device 120 (S455) after or before the first wireless communications network transmit the transmission instruction to the update device 120 through the first wireless communications network (S451). In this manner, the update device 120 will transmit the update file through the second wireless communications network after receiving the transmission instruction transmitted from the management end 110 through the first wireless communications network (S470).

After the wireless communications module 230 at the target device 130 receives the update file transmitted from the update device 120 through the second wireless communications network, the update module 250 at the target device 130 may use the firmware received by the wireless communications module 230 to update the firmware stored in the storage medium 210 of the target device 130 (S480). In this embodiment, assume the update module 250 may combine the fragments of the update file received according to an identification thereof into an update file, and write the combined update file into the site storing the firmware in the storage medium 210, thereby the firmware updating process is finished.

After the update module 250 at the target device 130 uses the update file to completely update the firmware, the switch module 270 at the target device 130 may switch the connection of the wireless communications module 230 from the second to the first wireless communications networks (S490). In this embodiment, assume the switch module 270 may write the activation flag presenting the firmware is finished updating into the storage medium 210 of the target device 130 and then reboot the target device 130.

When the target device 130 executes the boot loader during rebooting, the boot loader may determine the target device 130 is booting normally according to the activation flag. Since the activation flag indicates the firmware updating is finished, the boot loader may select the wireless communications module 230 to connect to the first wireless communications and then execute the updated firmware, so that the target device 130 may operate normally with the updated firmware executed. In this manner, the wireless communications module 230 may switch its connection with the second wireless communications network to the first wireless communications network.

When the updated firmware begins to operate within the target device 130, it may read out the activation flag stored in the storage medium 210 at the target device 130, and determine the firmware as having been updated by referring to the activation flag. At this time, the wireless communications module 230 transmits a successful updating message to the management end 110 through the first wireless communications network.

As such, the firmware of the target device 130 may be updated without occupying a bandwidth provided on the first wireless communications network by using the present invention.

In the above embodiment, if not all the target devices 10 are required to be updated, then the update device 120 or the detection device broadcasts the detection message through the first wireless communications network, which is shown as FIG. 4B, before the management end 110 transmits the update instruction to the target device 130 (S410). After the wireless communications module 230 of each of the target devices 130 receives the detection message broadcast by the update device 120 or the detection device, it may transmit the response message corresponding to the detection message received to the update device 120 or the management end 110 through the first wireless communications network (S420).

No matter the wireless communication module 230 of the target device 130 transmits the response message to the update device 120 or the management end 110, the management end 110 may all acquire the device list (S430). For example, the update device 120 or the management end 110 may establish the device list according to the identification of the target device 130 in the response messaged received. In the case of the update device 120, it may transmit the device list to the management end 110 after the device list is established.

After the management end 110 receives the device list (S430), the management end 110 may select the target device 13 required to be updated from the device list (S440). In this embodiment, assume the management server may acquire the device list and transmit the acquired device list to the management client end 112. In response, the management client end 112 may display the identification of the target device 130 according to the device list, so that the manager may select the target device 130 to be updated.

Thereafter, the management end 110 may transmit the update instruction to the target device 130 selected (S451), so that the target device having received the update instruction may launch the updating process as mentioned above (S460, S480, and S490).

In summary, the system and method of the present invention has the difference as compared to the prior art that the target device is switched to connect to the second wireless communications network from the first wireless communications network upon receiving the update instruction and receives the update file through the second wireless communications network, and then connects back to the first wireless communications network from the second wireless communications network after finishing the firmware updating by using the update file, whereby the issue encountered in the prior art may be solved where a bandwidth used by other devices working normally may be avoided influencing when device downloads new firmware and the technical efficacy updating the firmware of concurrent multiple target devices may be further achieved.

Furthermore, the method for updating a firmware through the hetero-network according to the present invention may be implemented in a hardware, a software or a combination thereof, and may also be implemented in a computer system in a concentrated fashion or discretely in interconnected elements in a computer system in a distributed fashion.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for updating a firmware by using a hetero-network, comprising:
a management end, transmitting an update instruction through a first wireless communications network;
an update device, transmitting an update file through a second wireless communications network; and
a target device, storing a firmware therein, switching to connect to the second wireless communications network from the first wireless communications network and receiving the update file through the second wireless communications network upon receiving the update instruction through the first wireless communications network, updating the firmware by using the update file, and switching back to connect to the first wireless communications network from the second wireless communications network.

2. The system for updating the firmware by using the hetero-network as claimed in claim 1, wherein the update device further broadcasts a detection message through the first wireless communications network, the target device further receives the detection message through the first wireless communications network and transmits a response message to the update device or the management end.

3. The system for updating the firmware by using the hetero-network as claimed in claim 2, wherein the update device further establishes a device list and transmits the device list to the management end through a first wireless communications network, and the management end further selects the target device from the device list.

4. The system for updating the firmware by using the hetero-network as claimed in claim 2, wherein the management end further establishes a device list and selects the target device according with the device list.

5. The system for updating the firmware by using the hetero-network as claimed in claim 1, wherein the management end further transmits a transmission instruction to the update device through a first wireless communications network, and the update device further transmits the update file after receiving the transmission instruction through a first wireless communications network.

6. The system for updating the firmware by using the hetero-network as claimed in claim 1, wherein the target device further reboots after setting an activation flag and selects to connect to the first wireless communications network or the second wireless communications network according to the activation flag during a booting process of the target device.

7. The system for updating the firmware by using the hetero-network as claimed in claim 1, wherein the target device further transmits an update success message to the management end thought the first wireless communications network when finishing updating the firmware.

8. A device for updating a firmware by using a hetero-network, comprising:
a wireless communications network module, connecting a first wireless communications network and receiving an update instruction through the first wireless communications network, and connecting a second wireless communications network and receiving an update file through the second wireless communications network;
a storage medium, storing a firmware therein;
an update module, electrically connected to the wireless communications network module and the storage medium, and updating the firmware by using the update file; and
a switch module, electrically connected to the wireless communications network module, the storage medium and the update module, which switching to connect to the second wireless communications network from the first wireless communications network upon receiving the update instruction through the first wireless communications network, and switching back to connect to the first wireless communications network from the second wireless communications network upon finishing the updating the firmware by the update module.

9. The device for updating the firmware by using the hetero-network as claimed in claim 8, wherein the wireless communications module, further receives a detection message through the first wireless communications network and transmits back a response message corresponding to the detection message through the first wireless communications module.

10. The device for updating the firmware by using the hetero-network as claimed in claim 8, wherein the switch module further sets an activation flag and reboots, and enables the device to select to connect to the first wireless communications network or the second wireless communications network according to the activation flag during a booting process of the device.

11. The device for updating the firmware by using the hetero-network as claimed in claim 8, wherein the wireless communications module further transmits an updating success message through the first wireless communications network upon finishing the updating the firmware by the update module.

12. A method for updating a firmware by using a hetero-network, comprising steps of:
transmitting an update instruction through a first wireless communications network by a management end to a target device;
switching to connect to a second wireless communications network from the first wireless communications network upon receiving the update instruction through the first wireless communications network by the target device;
transmitting an update file through the second wireless communications network by an update device;
receiving the update file through the second wireless communications network by the target device, and updating a firmware stored in the target device by using the update file; and
switching back to connect to the first wireless communications network from the second wireless communications network by the target device.

13. The method for updating the firmware by using the hetero-network as claimed in claim 12, further comprising steps of broadcasting a detection message through the first wireless communications network by the update device or a detection device, and transmitting a response message to the update device or the management end through the first wireless communications network after the target device receives the detection message through the first wireless communications network, prior to the step of transmitting the update instruction through the first wireless communications network by the management end to the target device.

14. The method for updating the firmware by using the hetero-network as claimed in claim 13, further comprising steps of establishing a device list according with the received response message by the update device, transmitting the device list from the update device to the management end through a first wireless communications network, and selecting the target device from the device list by the management end, after the step of transmitting the response message to the update device through the first wireless communications network.

15. The method for updating the firmware by using the hetero-network as claimed in claim 13, further comprising steps of establishing a device list according with the received response message and selecting the target device from the device list by the management end, after the step of transmitting the response message to the update device through the first wireless communications network.

16. The method for updating the firmware by using the hetero-network as claimed in claim 12, wherein the step of transmitting the update file through the second wireless communications network by the update device, further comprising a step of transmitting a transmission instruction from the management end to the update device through a first wireless communications network, so that the update device transmits the update file after receiving the transmission instruction through a first wireless communications network.

17. The method for updating the firmware by using the hetero-network as claimed in claim 12, further comprising steps of rebooting after setting an activation flag, and selecting to connect to the second wireless communications network according to the activation flag during a booting process of the target device, prior to the step of receiving the update file through the second wireless communications network by the target device.

18. The method for updating the firmware by using the hetero-network as claimed in claim 12, wherein the step of switching back to connect to the first wireless communications network from the second wireless communications network by the target device, further comprising steps of rebooting after setting an activation flag, and selecting to connect to the first wireless communications network according to the activation flag during a booting process of the target device.

19. The method for updating the firmware by using the hetero-network as claimed in claim 12, further comprising a step of transmitting an update success message from the target device to the management end thought the first wireless communications network when finishing updating the firmware, after the step of updating a firmware stored in the target device by using the update file.
